(19) United States
(12) Patent Application Publication
(10) Pub. No.: US 2020/0142718 A1
(43) Pub. Date: May 7, 2020

(54) ACCESSING APPLICATION FEATURES FROM WITHIN A GRAPHICAL KEYBOARD

(71) Applicant: Google LLC, Mountain View, CA (US)

(72) Inventors: Michael Dewey Burks, Los Altos, CA (US); Alan Ni, San Francisco, CA (US); Christian Paul Charsagua, Oakland, CA (US)

(21) Appl. No.: 16/619,067

(22) PCT Filed: Mar. 27, 2018
(86) PCT No.: PCT/US2018/024639

§ 371 Date: Dec. 3, 2019

Related U.S. Application Data
(60) Provisional application No. 62/525,571, filed on Jun. 27, 2017.

(51) Int. Cl. G06F 9/451; G06F 3/0488; G06F 3/0485; G06F 3/0482

(52) U.S. Cl. CPC G06F 9/451; G06F 3/0482; G06F 3/0485; G06F 3/04886

(57) ABSTRACT

A keyboard application executing at a computing device is described that outputs, for display, a graphical keyboard that includes an embedded-application strip. The embedded-application strip includes one or more graphical elements, with each graphical element corresponding to a particular embedded-application from a plurality of embedded-applications that are each executable by the keyboard application. The keyboard application receives user input that selects the embedded-application strip, determines a particular embedded-application based on the user input, and launches the particular embedded-application.

### BACKGROUND

Despite being able to simultaneously execute several applications, some mobile computing devices can only present a single graphical user interface (GUI) at a time. A user of such a mobile computing device may have to provide inputs to switch between different application GUIs to complete a particular task. For example, as a user of a mobile computing device types a message with a graphical keyboard that is displayed in a messaging GUI, the user may want to insert information into the message that is maintained outside the messaging GUI. The user may have to provide inputs to: first navigate outside of the messaging GUI, second copy the information, and third navigate back to the messaging GUI to paste the information into the message. Providing several inputs to perform various tasks can be tedious, repetitive, and time consuming.

### SUMMARY

In general, this disclosure is directed to techniques for enabling a keyboard application to provide, from within a keyboard GUI, access to content normally only accessible from other applications or services that execute outside the keyboard application. The keyboard application executes one or more embedded-applications that each act as a respective conduit for obtaining information that may otherwise only be accessible by navigating outside the keyboard GUI. Each embedded-application enables the keyboard application to provide a complete user experience associated with that embedded-application, fully within the keyboard GUI. The keyboard GUI provides an interface element from which a user may quickly switch between embedded-application experiences.

By providing a keyboard GUI that enables quick access to one or more embedded-applications executing inside a keyboard application, an example keyboard application may provide access to content, from within the keyboard GUI, that would normally only be accessible from a GUI of an application or service executing outside a graphical keyboard application. In this way, techniques of this disclosure may reduce the amount of time and the number of user inputs required to obtain information from within a keyboard application, which may simplify the user experience and may reduce power consumption of the computing device.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are conceptual diagrams illustrating an example computing device that is configured to present a graphical keyboard that executes one or more embedded-applications, in accordance with one or more aspects of the present disclosure.

FIG. 2 is a block diagram illustrating an example computing device that is configured to present a graphical keyboard that executes one or more embedded-applications, in accordance with one or more aspects of the present disclosure

FIG. 3 is a flowchart illustrating example operations of a computing device that is configured to present a graphical keyboard that executes one or more embedded-applications, in accordance with one or more aspects of the present disclosure.

FIGS. 4A-4C are conceptual diagrams illustrating example graphical user interfaces of an example computing device that is configured to present a graphical keyboard that executes one or more embedded-applications, in accordance with one or more aspects of the present disclosure.

FIGS. 5A and 5B are conceptual diagrams illustrating example graphical user interfaces of an example computing device that is configured to present a graphical keyboard that executes one or more embedded-applications, in accordance with one or more aspects of the present disclosure.

FIGS. 6A and 6B are conceptual diagrams illustrating example graphical user interfaces of an example computing device that is configured to present a graphical keyboard that executes one or more embedded-applications, in accordance with one or more aspects of the present disclosure.

FIGS. 7A and 7B are conceptual diagrams illustrating example graphical user interfaces of an example computing device that is configured to present a graphical keyboard that executes one or more embedded-applications, in accordance with one or more aspects of the present disclosure.

### DETAILED DESCRIPTION

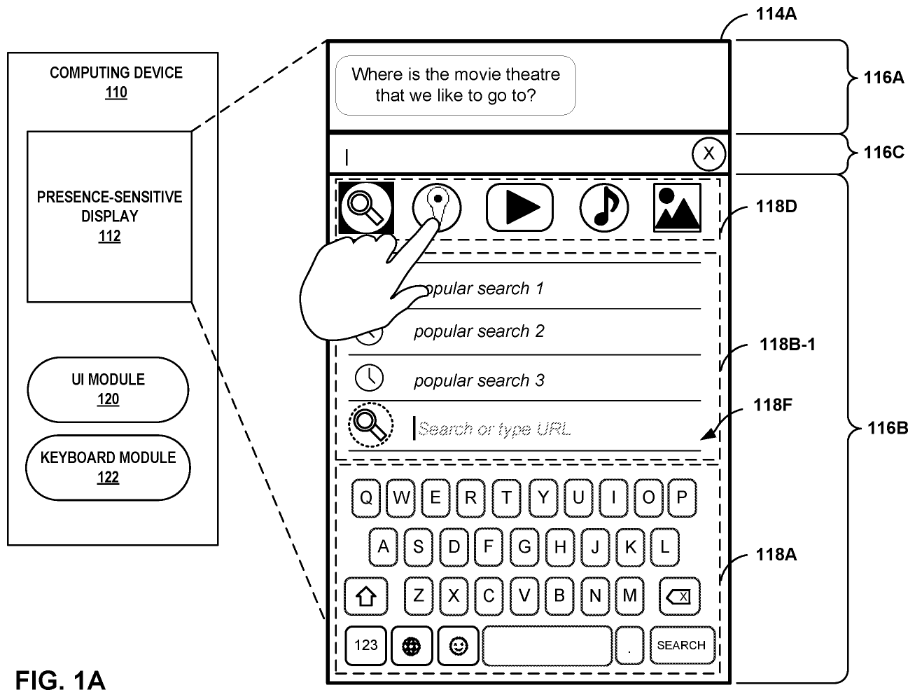

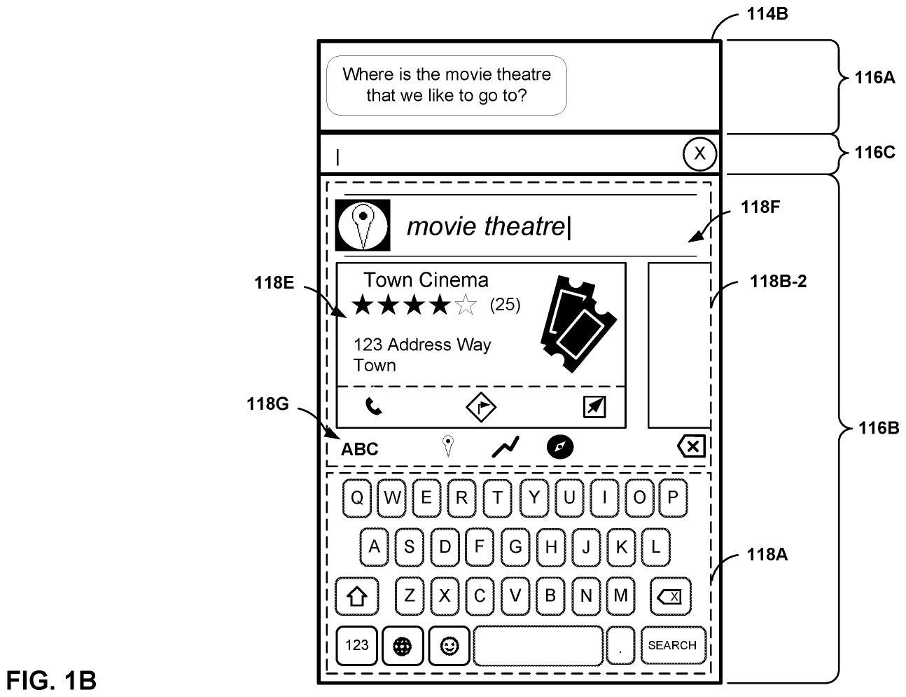

FIGS. 1A and 1B are conceptual diagrams illustrating an example computing device 110 that is configured to present a graphical keyboard that executes one or more embedded-applications, in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122. Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of a user interface (e.g., user interfaces 14A and 14B), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interfaces 114A and 114B (collectively referred to as “user interfaces 114) which, as shown in FIGS. 1A and 1B, are a graphical user interface of a chat application executing at computing device 110 and includes various graphical elements displayed at various locations of PSD 112.

As shown in FIGS. 1A and 1B, user interfaces 114 are a chat user interface. However, user interfaces 114 may be any graphical user interface which includes a graphical keyboard. User interfaces 114 each include output region 116A, graphical keyboard 116B, and edit region 116C. A user of computing device 110 may provide input at graphical keyboard 116B to produce characters within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interfaces 114). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 represents an application, service, or component executing at or accessible to computing device 110 that provides computing device 110 with graphical keyboard 116B which is configured to provide, from within graphical keyboard 116B, access to content typically maintained by other applications or services that execute outside keyboard module 122. Computing device 110 may download and install keyboard module 122 from an application or application extension repository of a service provider (e.g., via the Internet). In other examples, keyboard module 122 may be preloaded during production of computing device 110.

Keyboard module 122 may manage or execute one or more embedded-applications that each serve as a respective conduit for obtaining information (e.g., secured and/or unsecured information) that may otherwise only be accessible by navigating outside the keyboard GUI (e.g., to a GUI of an application or computing platform that is separate and distinct form keyboard module 122). Keyboard module 122 may switch between operating in text-entry mode in which keyboard module 122 functions similar to a traditional graphical keyboard (e.g., generating a graphical keyboard layout for display at PSD 112, mapping detected inputs at PSD 112 to selections of graphical keys, determining characters based on selected keys, or predicting or autocorrecting words and/or textual phrases based on the characters determined from selected keys), or embedded-application mode in which keyboard module 122 provides various embedded-application experiences.

In order to provide access to secured information that may otherwise only be accessible by navigating outside the keyboard GUI, keyboard module 122 requires explicit permission from a user to access such information. In some cases, keyboard module 122 allows the user to provide credentials, from within graphical keyboard 116B, to grant (and revoke) keyboard module 122 access to secured information. And in some cases, keyboard module 122 obtains access to the secured information via prior user consent obtained outside graphical keyboard 116B (e.g., by a different application or computing platform). In either case, keyboard module 122 provides a clear and unambiguous way for the user to revoke access to such information.

Keyboard module 122 may be a stand-alone application, service, or module executing at computing device 110 and, in other examples, keyboard module 122 may be a sub-component, such as an extension, acting as a service for other applications or device functionality. For instance, keyboard module 122 may be a keyboard extension that operates as a sub-component of a stand-alone keyboard application any time computing device 110 requires graphical keyboard input functionality. Keyboard module 122 may be integrated into a chat or messaging application executing at computing device 110 whereas, in other examples, keyboard module 122 may be a stand-alone application or subroutine that is invoked by a container application, such as a separate application or operating platform of computing device 110 that calls on keyboard module 122 any time the container application requires graphical keyboard input functionality.

For example, when keyboard module 122 forms part of a chat or messaging application executing at computing device 110, keyboard module 122 may provide the chat or messaging application with text-entry capability as well as access to one or more embedded-applications executing as part of keyboard module 122. Similarly, when keyboard module 122 is a stand-alone application or subroutine that is invoked by an application or operating platform of computing device 110 any time an application or operating platform requires graphical keyboard input functionality, keyboard module 122 may provide the invoking application or operating platform with text-entry capability as well as access to one or more embedded-applications executing as part of keyboard module 122.

Graphical keyboard 116B includes graphical elements displayed as graphical keys 118A, embedded-application experience 118B-1 and 118B-2 (collectively “embedded-application experiences 118B”), as well as embedded-application strip 118D. Keyboard module 122 may output information to UI module 120 that specifies the layout, within user interfaces 114, of graphical keys 118A, embedded-application strip 118D, and embedded-application experiences 118B. For example, the information may include instructions that specify locations, sizes, colors, and other characteristics of graphical keys 118A. Based on the information received from keyboard module 122, UI module 120 may cause PSD 112 to display graphical keys 118A as part of graphical keyboard 116B of user interfaces 114.

Each key of graphical keys 118A may be associated with one or more respective characters (e.g., a letter, number, punctuation, or other character) displayed within the key. A user of computing device 110 may provide input at locations of PSD 112 at which one or more of graphical keys 118A are displayed to input content (e.g., characters, iconographic symbol phrase predictions, etc.) into edit region 116C (e.g., for composing messages that are sent and displayed within output region 116A or for inputting a search query that computing device 110 executes from within graphical keyboard 116B). Keyboard module 122 may receive information from UI module 120 indicating locations associated with input detected by PSD 112 that are relative to the locations of each of the graphical keys. Using a spatial and/or language model, keyboard module 122 may translate the inputs to selections of keys and characters, words, and/or phrases.

For example, PSD 112 may detect user inputs as a user of computing device 110 provides the user inputs at or near a location of PSD 112 where PSD 112 presents graphical keys 118A. The user may type at graphical keys 118A to enter text of a message at edit region 116C. UI module 120 may receive, from PSD 112, an indication of the user input detected by PSD 112 and output, to keyboard module 122, information about the user input. Information about the user input may include an indication of one or more touch events (e.g., locations and other information about the input) detected by PSD 112.

Based on the information received from UI module 120, keyboard module 122 may map detected inputs at PSD 112 to selections of graphical keys 118A, determine characters based on selected keys 118A, and predict or autocorrect words and/or phrases determined based on the characters associated with the selected keys 118A. For example, keyboard module 122 may include a spatial model that may determine, based on the locations of keys 118A and the information about the input, the most likely one or more keys 118A being selected as the user types text of the message. Responsive to determining the most likely one or more keys 118A being selected, keyboard module 122 may determine one or more characters, words, and/or phrases that make up the text of the message. For example, each of the one or more keys 118A being selected from a user input at PSD 112 may represent an individual character or a keyboard operation. Keyboard module 122 may determine a sequence of characters selected based on the one or more selected keys 118A. In some examples, keyboard module 122 may apply a language model to the sequence of characters to determine one or more the most likely candidate letters, morphemes, words, and/or phrases that a user is trying to input based on the selection of keys 118A. Keyboard module 122 may send the sequence of characters and/or candidate words and phrases to UI module 120 and UI module 120 may cause PSD 112 to present the characters and/or candidate words determined from a selection of one or more keys 118A as text within edit region 116C.

In addition to performing traditional, graphical keyboard operations used for text-entry, keyboard module 122 of computing device 110 also executes one or more embedded-applications that are each configured to provide, from within graphical keyboard 116B, an embedded-application experience that gives a user access to content typically maintained by other applications or services that execute outside keyboard module 122. That is, rather than requiring a user of computing device 110 to navigate away from user interfaces 114 (e.g., to a different application or service executing at or accessible from computing device 110) to access content maintained by other applications or services that execute outside keyboard module 122, keyboard module 122 may operate in embedded-application mode in which keyboard module 122 may execute one or more embedded-applications that are configured to obtain and present content maintained or stored outside of keyboard application module 122, from within the same region of PSD 112 at which graphical keyboard 116B is displayed.

Embedded-application strip 118D is a user interface element of graphical keyboard 116B that provides a way for users to cause keyboard module 122 to transition from text-entry mode into embedded-application mode, as well as to transition between different embedded-application experiences 118B, that are presented by keyboard module 122, while executing in embedded-application mode. Embedded-application strip 118D includes one or more graphical buttons with icons, graphical elements, and/or labels. Each button is associated with a particular embedded-application that keyboard module 122 manages and executes when operating in embedded-application mode. A user may provide input (e.g., a gesture) at USD 112 to select an embedded-application from embedded-application strip 118D. In some examples, embedded-application strip 118D may persist during embedded-application mode, regardless as to which embedded-application experience is a current embedded-application experience, making it easier for a user to switch between embedded-application experiences. And in some instances, for instance as shown by the highlighting of the search embedded-application button in user interface 114A, keyboard module 122 may cause embedded-application strip 118D to highlight the button associated with a current embedded-application experience. In other cases, keyboard module 122 may hide or minimize embedded-application strip 118D when embedded-application experiences are displayed. Embedded-application strip 118D may include graphical buttons in a line, a grid, or other arrangement. Embedded-application strip 118D may dynamically change which graphical buttons are shown or how graphical buttons are positioned and ordered, potentially based on user context (e.g., time of day, location, input at keys 118A, application focus, etc.). Embedded-application strip may be customizable such that a user may provide input to computing device 110 that causes keyboard module 122 to add or remove and arrange graphical buttons on embedded-application strip 118D to reflect their personal preferences.

Embedded-application experiences 118B are specialized GUI environments provided by embedded-applications that execute within and under the control of (or, in other words, within the operational context of) keyboard module 122 to access information provided by services and applications that traditionally operate outside a graphical keyboard application. Each embedded-application may be either a first party application created by the same developer as keyboard application module 122 or a third-party application created by a different developer as keyboard application module 122. Text-entry mode may in some examples be implemented by keyboard module 122 as a text-entry embedded-application experience with an associated button in embedded-application strip 118D.

Each embedded-application may execute as a separate routine or subroutine that is under control of (or, again in other words, within the operational context of) keyboard module 122. Keyboard module 122 may initiate or terminate the application thread or threads associated with each embedded-application in its control, request or manage memory associated with each embedded-application in its control, and otherwise manage or handle the functionality and/or resources (e.g., memory, storage space, etc.) provided to each embedded-application in its control.

Each embedded-application is more sophisticated than link to outside services or applications that other types of keyboard applications may provide. Each embedded-application is itself a separate application or part of keyboard module 122 and is configured to provide specific functionality or operations while remaining under control of keyboard module 122. In other words, each embedded-application is more sophisticated than a link to a separate application or service executing outside keyboard module 122 or accessible from computing device 110. That is, an embedded-application executing as part of keyboard module 122 may provide output, decipher inputs, and perform functions for maintaining an embedded-application experience so as to enable the keyboard application to perform one or more sophisticated functions related to each embedded-application experience, without having to call on or navigate to other services or resources that execute outside the keyboard application.

Embedded-application experience 118B-1 of FIG. 1A is a GUI associated with a search type embedded-application executing as part of keyboard module 122. The search type embedded-application may perform search operations (e.g., informational searches local to computing device 110 and/or on the internet). Embedded-application experience 118B-1 includes a list of popular search queries positioned above search query entry box 118F that is configured to receive textual input for a user to enter a specific search query.

As shown in FIG. 1B, embedded-application experience 118B-2 is a GUI associated with a map or navigation type embedded-application executing as part of keyboard module 122. The map or navigation type embedded-application may perform map or navigational operations (e.g., informational searches for places). Embedded-application experience 118B-2 includes location entry box 118F is configured to receive textual input for a user to enter a specific location. Location entry box is positioned above a carousel of search results 118E that the map or navigation type embedded-application returns from executing a location search for information contained in location entry box 118F. A user may provide an input (e.g., a swipe across) at search results 118E to swipe through the different result cards contained in the carousel. A user may provide an input (e.g., a swipe up) at search results 118E to insert a particular result card into edit region 116C (e.g., for subsequent sending as part of a text message).

An embedded-application experience 118B-2 may include application controls, such as application controls 118G of FIG. 1B. Each application control may control a specific function related to the embedded-application that is providing the embedded-application experience. For instance, application controls 118G include a “return to text-entry mode” control for causing keyboard module 122 to return to text-entry mode, a “insert current location” control for configuring the embedded-application to obtain a current location of computing device 110, a “popular location” control for configuring the embedded-application to provide one or more popular locations nearby, and a “location search” control for configuring the embedded-application to perform location searches.

Each embedded-application may be launched, controlled, and/or terminated by keyboard module 122. Each embedded-application may operate as a conduit to (or, in other words, an interface by which to) communicate with applications or services executing outside of a keyboard application provided by keyboard module 122 in order to obtain information that may be used within the keyboard application. Examples of applications or services that may be accessed by an embedded-application executing as part of keyboard module 122 include: multi-media streaming applications, map or navigation applications, photo applications, search applications, or any other type of embedded-application.

By enabling a keyboard application to execute one or more embedded-applications that enable quick access, from a graphical keyboard context, to content maintained by other applications or services that execute outside the keyboard application, an example computing device may provide a way for a user to quickly obtain content maintained by other applications or services that execute outside the keyboard application without having to switch between several different applications and application GUIs. In this way, techniques of this disclosure may reduce the amount of time and the number of user inputs required to obtain information from within a keyboard context, which may simplify the user experience and may reduce power consumption of the computing device. For example, the techniques may eliminate the need for a user to provide several inputs to navigate to a different application that exists outside of the keyboard application or outside a container application that is calling on the keyboard application.

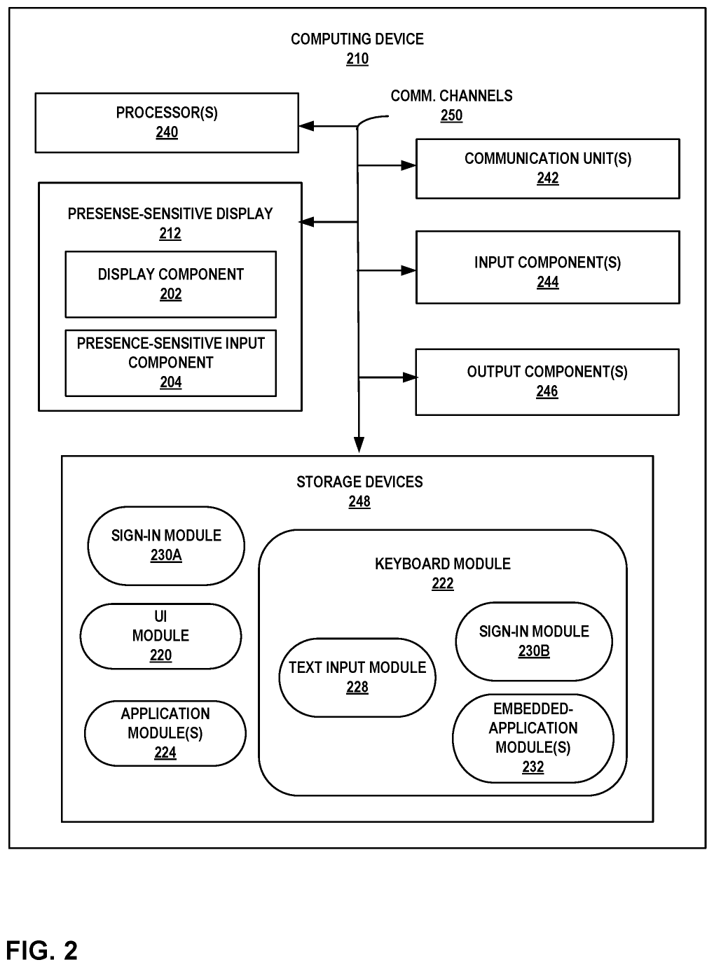

FIG. 2 is a block diagram illustrating an example computing device that is configured to present a graphical keyboard that executes one or more embedded-applications, in accordance with one or more aspects of the present disclosure. Computing device 210 of FIG. 2 is described below as an example of computing device 10 of FIG. 1. FIG. 2 illustrates only one example of computing device 210, and many other examples of computing device 210 may be used in other instances. Computing device 210 may include a subset of the components included in FIG. 2 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 include UI module 220, keyboard module 222, sign-in module 230A, and one or more application modules 224. Keyboard module 222 includes text input module 228, sign-in module 230B, and embedded-application modules 232. Sign-in modules 230A and 230B are referred to collectively as sign-in modules 230.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 may be similar to PSD 112 of computing device 110 and includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interfaces 114A and 114B of FIGS. 1A and 1B).

While illustrated as an internal component of computing device 210, PSD 212 may also represent an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three-dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 228, 230, and 232 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 228, 230, and 232. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 228, 230, and 232 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated modules 220, 222, 224, 228, 230, and 232. Storage components 248 may include a memory configured to store data or other information associated with modules 220, 222, 224, 228, 230, and 232.

UI module 220 may include all functionality of UI module 120 of computing device 110 of FIG. 1 and may perform similar operations as UI module 120 for managing a user interface (e.g., user interfaces 114A and 114B) that computing device 210 provides at presence-sensitive display 212 for handling input from a user. For example, UI module 220 of computing device 210 may query keyboard module 222 for a keyboard layout (e.g., an English language QWERTY keyboard, etc.). UI module 220 may transmit a request for a keyboard layout over communication channels 250 to keyboard module 222. Keyboard module 222 may receive the request and reply to UI module 220 with data associated with the keyboard layout. UI module 220 may receive the keyboard layout data over communication channels 250 and use the data to generate a user interface. UI module 220 may transmit a display command and data over communication channels 250 to cause PSD 212 to present the user interface at PSD 212.

In some examples, UI module 220 may receive an indication of one or more user inputs detected at PSD 212 and may output information about the user inputs to keyboard module 222. For example, PSD 212 may detect a user input and send data about the user input to UI module 220. UI module 220 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 220 may determine that the detected user input is associated the graphical keyboard. UI module 220 may send an indication of the one or more touch events to keyboard module 222 for further interpretation. Keyboard module 22 may determine, based on the touch events received from UI module 220, that the detected user input represents an initial selection of one or more keys of the graphical keyboard.

Application modules 224 represent all the various individual applications and services executing at and accessible from computing device 210 that may rely on a graphical keyboard having integrated iconographic symbol phrase prediction. A user of computing device 210 may interact with a graphical user interface associated with one or more application modules 224 to cause computing device 210 to perform an operation or perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 210.

Keyboard module 222 may include all functionality of keyboard module 122 of computing device 110 of FIG. 1 and may perform similar operations as keyboard module 122 for providing, from within a graphical keyboard, access to content typically maintained by other applications or services that execute outside keyboard module 222. Keyboard module 222 may include various submodules, such as text input module 228, sign-in modules 230, and embedded-application modules 232, which may perform the functionality of keyboard module 222.

Text input module 228 may include a spatial model that receives one or more touch events as input, and outputs a character or sequence of characters that likely represents the one or more touch events, along with a degree of certainty or spatial model score indicative of how likely or with what accuracy the one or more characters define the touch events. In other words, the spatial model of text input module 228 may infer touch events as a selection of one or more keys of a keyboard and may output, based on the selection of the one or more keys, a character or sequence of characters.

Text input module 228 may further include a language model. When keyboard module 222 operates in text-entry mode, the language model of text input module 228 may receive a character or sequence of characters as input, and output one or more candidate characters, words, or phrases that the language model identifies from a lexicon as being potential replacements for a sequence of characters that the language model receives as input for a given language context (e.g., a sentence in a written language). Keyboard module 222 may cause UI module 220 to present one or more of the candidate words at edit regions 116C of user interfaces 114A and 114B.

Embedded-application modules 232 represents one or more embedded-applications that each serve as a respective conduit for obtaining information that may otherwise only be accessible by navigating outside a keyboard GUI provided by keyboard module 222. Keyboard module 222 may switch between operating in text-entry mode in which keyboard module 222 functions similar to a traditional graphical keyboard, or embedded-application mode in which keyboard module 222 performs various operations for executing one or more integrated embedded-applications and providing various embedded-application experiences. Each embedded-application of embedded-application modules 232 may be managed by keyboard module 222 and may execute at the discretion and control of keyboard module 222. For example, unlike each of application modules 224 that execute independent of keyboard module 222, keyboard module 222 may initiate and terminate each embedded-application thread that executes at processors 240. Keyboard module 222 may request memory and/or storage space on behalf of each of embedded-application modules 232.

In contrast to application modules 224 that provide user experiences outside of a keyboard application, embedded-application modules 232 provide user experiences from within the keyboard GUI provided by keyboard module 222. For example, a messaging application of application modules 224 may call on keyboard module 222 to provide a graphical keyboard user interface within the user interface of the messaging application. If a user wishes to share content in a message that is associated with a video application of application modules 224, the user may, with other devices, have to navigate away from the user interface of the messaging application to obtain that content. Keyboard module 222 may however provide an interface element (e.g., an embedded-application strip) from which the user can provide input that causes keyboard module 222 to launch a video, embedded-application of embedded-application modules 232 from which the user may obtain the content he or she wishes to share in the message without having to navigate outside the keyboard GUI provided by keyboard module 222 and/or the messaging application interface.

Keyboard module 222 may download and install embedded-application modules 232 from an application or application extension repository of a service provider (e.g., via the Internet. Embedded-application modules 232 may be preloaded during production of computing device 210 or may be installed in computing device 210 as part of an initial install with keyboard module 222. Keyboard module 222 may provide access to an embedded-application store from which a user may provide input to select and cause keyboard module 222 to download and install a particular embedded-application.

Numerous examples of embedded-application modules 232 may exist and include, a fitness application, a photo application, a video application, a music application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other embedded-applications that may execute at computing device 210.

In some cases, embedded-application modules 232 may be associated with personal or cloud-based user accounts or other “personal information”. Sign-in modules 230 may enable a user to provide credentials (e.g., from within the graphical keyboard provided by keyboard module 222 or via a settings menu or other interface from outside keyboard module 222) that enable keyboard module 222 to access the personal information or cloud-based user account associated with one or more embedded-application modules 232 that are executed by keyboard module 222.

Sign-in module 230A represents a component or module of an operating platform or operating system of computing device 210 whereas sign-in module 230B represents a component or module of keyboard module 222. In combination, sign-in modules 230 provide the functionality described below for obtaining user credentials, and obtaining and revoking access to information based on the credentials, on behalf of keyboard module 222. In other words, using sign-in modules 230, keyboard module 222 may initiate a sign-in flow from keyboard module 222, but to protect privacy the actual sign-in may be done outside the keyboard module 222 by sign-in module 230A. Keyboard module 222 may switch back and forth between sign-in module 230A and 230B, depending on security permissions associated with keyboard module 222.

For example, after obtaining explicit permission from a user to make use of and store personal information of the user, a search application from application modules 224 may maintain a search history association with the user (e.g., the user account associated with the provided credentials identifying the user). The search application may maintain the search history, or a copy of the search history, at a remote computing device (e.g., at a server in the cloud). From within the graphical keyboard provided by keyboard module 222, sign-in modules 230 may call on a security component of an operating system of computing device 210 to request that the security component obtain the credentials of the user for accessing the search history, and using the credentials, the security component may authorize sign-in modules 230 to enable a corresponding search related embedded-application from embedded-application modules 232 to access the search history stored at the remote computing device.

Search history is one example of personal information that a user may access using keyboard module 222 and the capabilities provided by sign-on module 230. Other examples of personal information include non-search information maintained by other application modules 224 (e.g., personal photos, emails, calendar invites, etc.). Also included as examples of personal information are “zero-state” information associated with an application. In other words, by accessing the stored personal zero-state information of an application, keyboard module 222 can cause a user experience of an embedded-application module 232 to appear similar to the appearance of a corresponding stand-alone application the last time a user interacted with that stand-alone application.

In addition to providing embedded-application modules 232 access to personal information, sign-in modules 230 can similarly revoke access to the personal information at any time of a user's choosing. That is, sign-in module may provide a way for a user of keyboard module 222 to sign-out of keyboard module 222 and prevent any of embedded-application modules 232 from accessing the personal information of the user.

In some instances, sign-in modules 230 may enable a user to provide credentials from within the graphical keyboard provided by keyboard module 222 that enable keyboard module 222 to access the personal information or cloud-based user account associated with one or more embedded-application modules 232 that are executed by keyboard module 222. In addition, or alternatively, sign-in modules 230 may enable a user to provide credentials via an outside entity (e.g., a settings menu or other interface from outside keyboard module 222) that enable keyboard module 222 to access the personal information or cloud-based user account associated with one or more embedded-application modules 232 that are executed by keyboard module 222. For example, a user may provide credentials to one of application modules 224 that sign-in modules 230 may use as authorization to access the personal information of the user. A user may provide credentials to an operating system or operating platform of computing device 210 that sign-in modules 230 may use as authorization to access the personal information of the user. In this way, instead of requiring users to explicitly have to log in, keyboard module 222 may automatically provide a personalized keyboard experience when the user is already signed into the outside entity.

Sign-in modules 230 may communicate with applications 224 and other applications and services that are accessible to computing device 210 so as to obtain secured information maintained by such applications and services. For example, sign-in modules 230 may send credentials obtained for a user to a remote computing device (e.g., a server) for validation. Sign-in modules 230 may send the credentials to a local application or process executing local to computing device 210 for validation. In any case, in response to outputting the credentials for validation, sign-in modules 230 of keyboard module 222 may receive an authorization or denial with respect to the validation. For instance, sign-in modules 230 may receive a message validating the credentials and thereby authorizing keyboard module 222 to make use of and access secured information associated with the credentials. Alternatively, sign-in modules 230 may receive a message denying the credentials and thereby preventing keyboard module 222 from making use of and accessing the secured information associated with the credentials

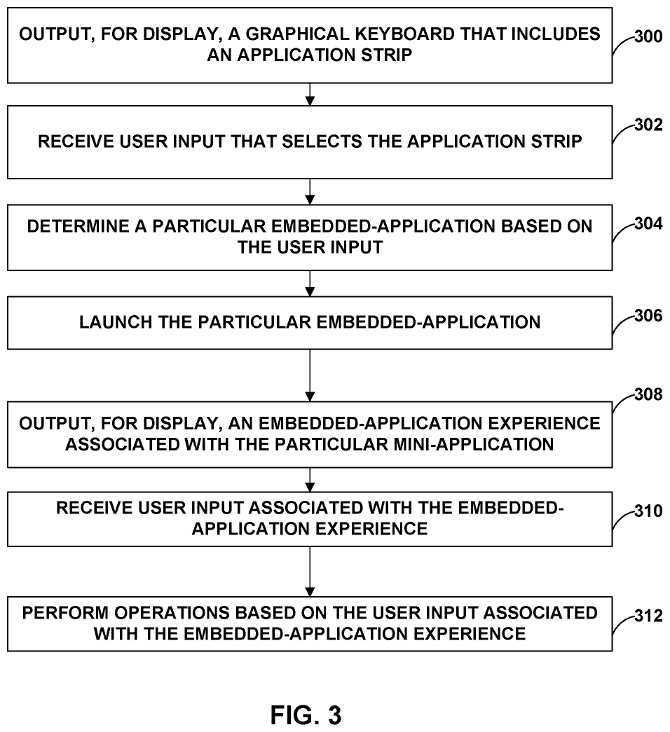

FIG. 3 is a flowchart illustrating example operations of a computing device that is configured to present a graphical keyboard that executes one or more embedded-applications, in accordance with one or more aspects of the present disclosure. The operations of FIG. 3 may be performed by one or more processors of a computing device, such as computing devices 110 of FIGS. 1A and 1B or computing device 210 of FIG. 2. For purposes of illustration only, FIG. 3 is described below within the context of computing device 110 of FIGS. 1A and 1B.

In operation, computing device 110 may output a graphical keyboard for display (300). For example, a chat application executing at computing device 110 may invoke keyboard module 122 (e.g., a standalone application or function of computing device 110 that is separate from the chat application) to present graphical keyboard 116B at PSD 112.

Computing device 110 may output, for display, a graphical keyboard that includes an embedded-application strip (300). For example, a user of computing device 110 may provide input to UID 112 that causes computing device 110 to execute a messaging application. UI module 120 may receive information from a messaging application that causes UI module 120 to output user interface 114A for display at UID 112. User interface 114A includes output region 116A for viewing sent and received messages, edit region 116C for previewing content that may be sent as a message, and graphical keyboard 116B for composing content that is inserted into edit region 116C.

UI module 120 may receive information directly from keyboard module 122, or via the messaging application, that instructs UI module 120 as to how graphical keyboard 116B is to be displayed at UID 112. For example, keyboard module 122 may send instructions to UI module 120 for causing UI module 120 to display keys 118A, embedded-application strip 118D, as well as an initial embedded-application experience 118B-1. In other examples, keyboard module 122 may send instructions to the messaging application that get passed on to UI module 120 for causing UI module 120 to display keys 118A, embedded-application strip 118D, as well as an initial embedded-application experience 118B-1.

Computing device 110 may receive user input that selects the embedded-application strip (302). For example, a user of computing device 110 may wish to interact with the map or navigation embedded-application of keyboard module 122. The user may gesture at or near a location of UID 112 at which embedded-application strip 118D is displayed.

Computing device 110 may determine a particular embedded-application based on the user input (304). For instance, keyboard module 122 may receive information from UI module 120 and UID 112 indicating the location or other characteristics of the input and determine that the input corresponds to a selection of the graphical button within embedded-application strip 118D that is associated with the map or navigational embedded-application.

Computing device 110 may launch the particular application (306). For example, in response to detecting user input that selects embedded-application strip 118D and in response to determining the particular embedded-application, keyboard module 122 may keyboard module 122 may launch or invoke the map or navigational embedded-application such that the map or navigational embedded-application executes as one or more application threads or processes that are under the control of keyboard module 122.

Computing device 110 may output, for display, an embedded-application experience associated with the particular embedded-application (308). For example, by launching the map or navigational embedded-application, keyboard module 122 may cause UI module 120 and UID 112 to display a second embedded-application experience that replaces the initial embedded-application experience. Keyboard module 122 may send instructions to UI module 120 for causing UI module 120 to display keys 118A, embedded-application strip 118D, as well as a subsequent embedded-application experience 118B-2 that is related to the map or navigational embedded-application.

Computing device 110 may receive user input associated with the embedded-application experience (310). For instance, from embedded-application experience 118B-2, a user of computing device 110 may provide input at keys 118A to input a location search query for a “movie theatre” in location entry box 118F.

Computing device 110 may perform one or more operations based on the user input associated with the embedded-application experience (312). For example, keyboard module 122 may obtain a carousel of search results 118E that the map or navigation type embedded-application returns from executing a location search for information contained in location entry box 118F. A user may provide an input (e.g., a swipe across) at search results 118E to swipe through the different result cards contained in the carousel. A user may provide an input (e.g., a swipe up) at search results 118E to insert a particular result card into edit region 116C (e.g., for subsequent sending as part of a text message).

There are many other operations that computing device 110 may perform in response to user input associated with an embedded-application experience. For example, keyboard module 122 may modify calendar entries associated with a calendar maintained or accessed by a calendar type embedded-application. Keyboard module 122 may stream media content (e.g., movies, music, TV shows, video clips, games, etc.) provided by an embedded-application. Keyboard module 122 may display or search photos provided by a photo management type embedded-application. Keyboard module 122 may display search results provided by a search type embedded-application.

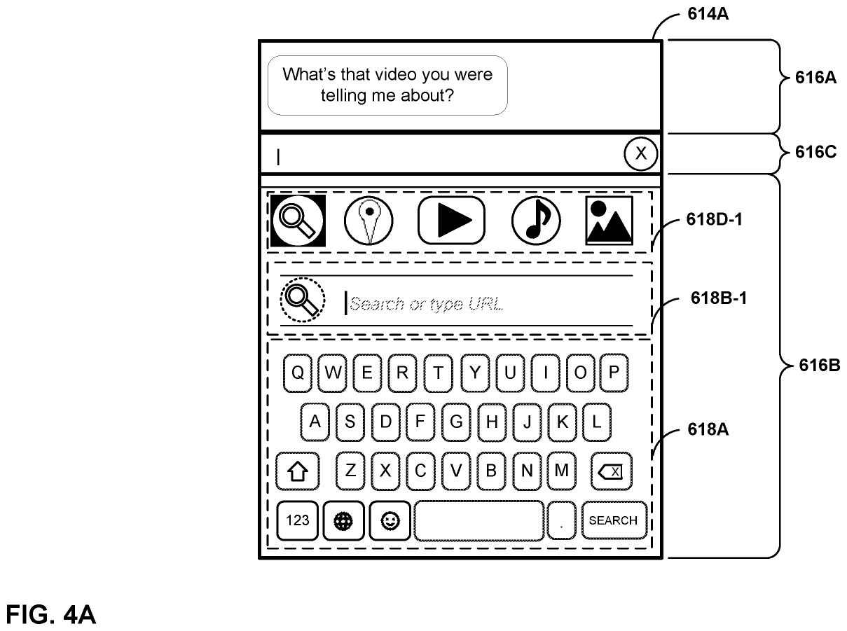

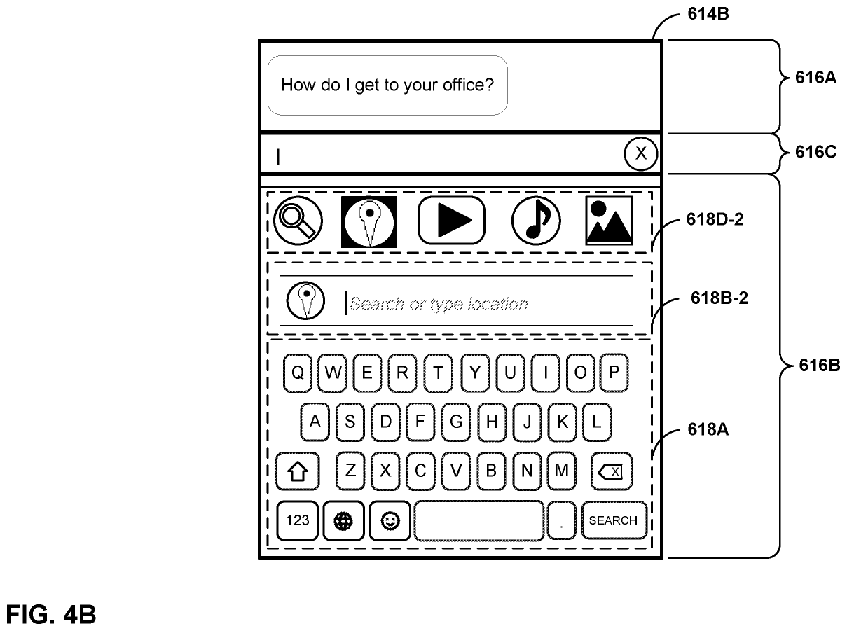

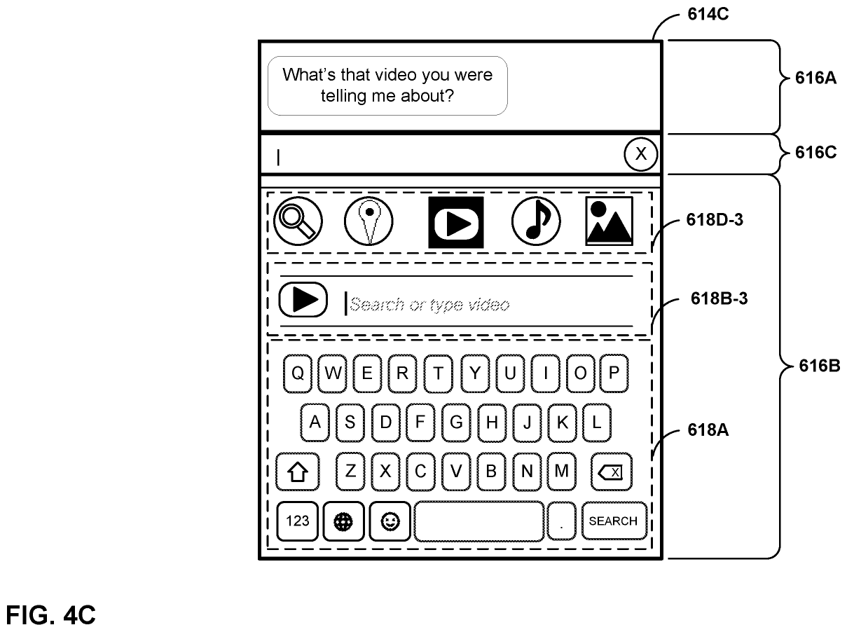

FIGS. 4A-4C are conceptual diagrams illustrating example graphical user interfaces of an example computing device that is configured to present a graphical keyboard that executes one or more embedded-applications, in accordance with one or more aspects of the present disclosure. FIGS. 4A-4C illustrate, respectively, example graphical user interfaces 614A-614C (collectively, user interfaces 614). However, many other examples of graphical user interfaces may be used in other instances. Each of graphical user interfaces 614 may correspond to a graphical user interface displayed by computing devices 110 or 210 of FIGS. 1A, 1B, and 2. FIGS. 4A-4C are described below in the context of computing device 110.

Graphical user interfaces 614 include output region 616A, edit region 616C, and graphical keyboard 616B. Graphical keyboard 616B includes a plurality of keys 618A, and embedded-application experience 618B-1 and embedded-application strip 618D-1, embedded-application experience 618B-2 and embedded-application strip 618D-2, or embedded-application experience 618B-3 and embedded-application strip 618D-3.

FIGS. 4A-4C show how keyboard module 122 may cause an embedded-application strip to change appearance via highlighting, color change, etc. to indicate to a user which particular embedded-application is executing and providing an embedded-application experience. For example, shown in FIG. 4A, embedded-application strip 618D-1 shows a search element being highlighted to indicate to a user of computing device 110 that embedded-application experience 618B-1 is associated with a search type embedded-application being execute by keyboard module 122. Shown in FIG. 4B, embedded-application strip 618D-2 shows a map or navigational element being highlighted to indicate to a user of computing device 110 that embedded-application experience 618B-2 is associated with a map or navigational type embedded-application being execute by keyboard module 122. Shown in FIG. 4C, embedded-application strip 618D-3 shows video element being highlighted to indicate to a user of computing device 110 that embedded-application experience 618B-3 is associated with a video type embedded-application being execute by keyboard module 122.

FIGS. 4A-4C also show how keyboard module 122 may cause an input region of an embedded-application experience to indicate to a user which particular embedded-application is executing and providing an embedded-application experience. For example, as shown in FIG. 4A, embedded-application experience 618B-1 includes a search element next to an input region, as shown in FIG. 4B, embedded-application strip 618D-2 includes a map or navigational element next to an input region, and as shown in FIG. 4C, embedded-application experience 618B-3 includes a video element next to an input region.

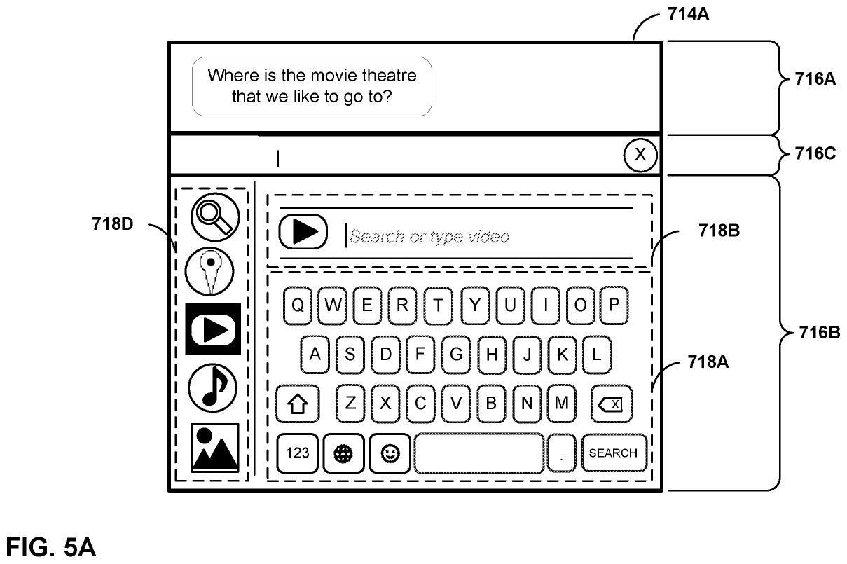

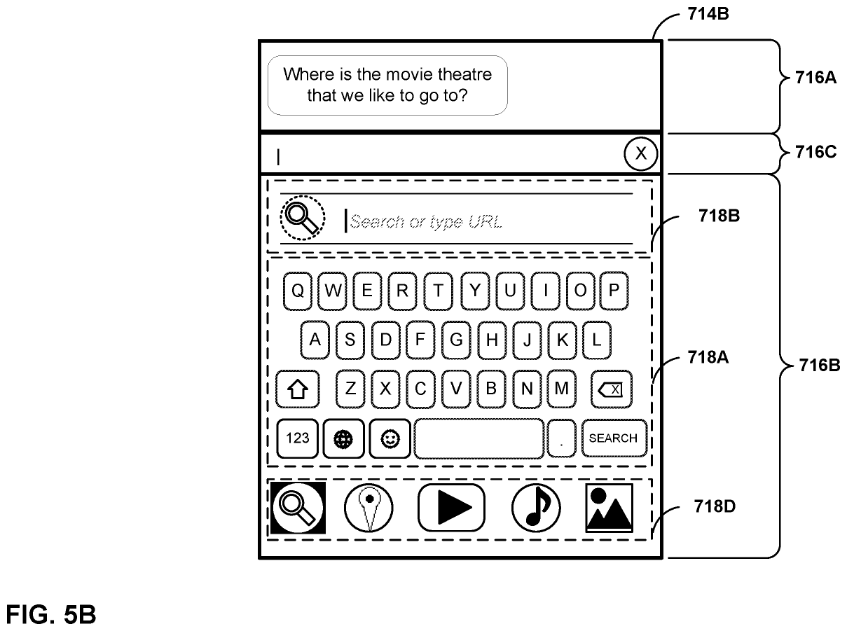

FIGS. 5A and 5B are conceptual diagrams illustrating example graphical user interfaces of an example computing device that is configured to present a graphical keyboard that executes one or more embedded-applications, in accordance with one or more aspects of the present disclosure. FIGS. 5A and 5B illustrate, respectively, example graphical user interfaces 714A-714B (collectively, user interfaces 714). However, many other examples of graphical user interfaces may be used in other instances. Each of graphical user interfaces 714 may correspond to a graphical user interface displayed by computing devices 110 or 210 of FIGS. 1A, 1B, and 2. FIGS. 5A and 5B are described below in the context of computing device 110.

Graphical user interfaces 714 include output region 716A, edit region 716C, and graphical keyboard 716B. Graphical keyboard 716B includes a plurality of keys 718A, embedded-application experience 718B, and embedded-application strip 718D.

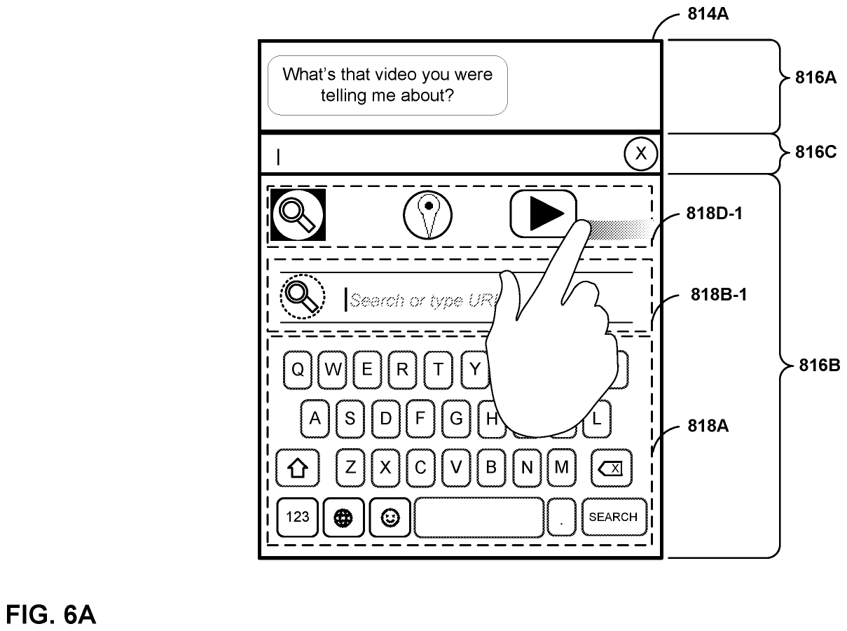

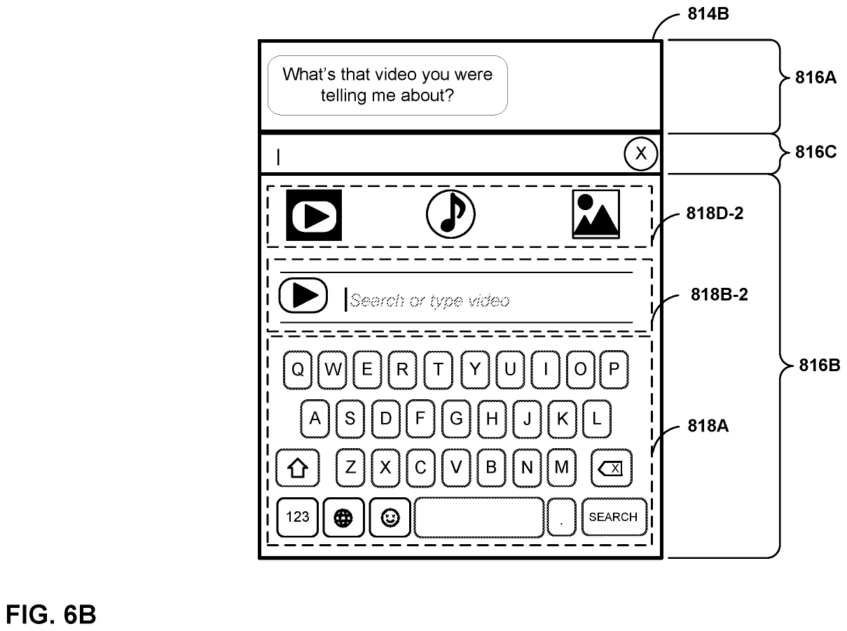

While in some cases, keyboard module 122 may cause UID 112 to display embedded-application strip 718D above keys 718A or between keys 718A and edit region 716C, in other examples, keyboard module 122 causes UID 112 to display application strip 718D in a different location of graphical keyboard 716B. For example, FIG. 5A shows how keyboard module 122 may cause UID 112 to display embedded-application strip 718D to the left or right of keys 118A. FIG. 5B shows how keyboard module 122 may cause UID 112 to display embedded-application strip 718D to below keys 118A. Keyboard module 122 may cause UID 112 to display embedded-application strip 718 within any part of graphical keyboard 716B that improves usability. In other words, embedded-application strip 718D can be placed anywhere within graphical keyboard 716B. In some cases, keyboard module 122 may cause UID 112 to split embedded-application strip 718D into multiple parts with a portion of embedded-application strip 718D being located at one part of graphical keyboard 716B and other portions of embedded-application strip 718D being located at different parts of graphical keyboard 716B. [0085] FIGS. 6A and 6B are conceptual diagrams illustrating example graphical user interfaces of an example computing device that is configured to present a graphical keyboard that executes one or more embedded-applications, in accordance with one or more aspects of the present disclosure. FIGS. 6A and 6B illustrate, respectively, example graphical user interfaces 814A-814B (collectively, user interfaces 814). However, many other examples of graphical user interfaces may be used in other instances. Each of graphical user interfaces 814 may correspond to a graphical user interface displayed by computing devices 110 or 210 of FIGS. 1A, 1B, and 2. FIGS. 6A and 6B are described below in the context of computing device 10.

Graphical user interfaces 814 include output region 816A, edit region 816C, and graphical keyboard 816B. Graphical keyboard 816B includes a plurality of keys 818A, embedded-application experience 818B-1 and embedded-application strip 818D-1, or embedded-application experience 818B-2 and embedded-application strip 818D-2. [0087] FIGS. 6A and 6B show how, while keyboard module 122 may cause embedded-application strips 818D-1 and 818D-2 to be static, keyboard module 122 may cause embedded-application strips 818D-1 and 818D-2 to be scrollable or have multiple tabs or pages. For example, FIG. 6A shows how keyboard module 122 may cause UID 112 to display embedded-application strip 818D-1 which includes a first group of graphical buttons. FIG. 6B shows how after detecting input at UID 112 at a location at which embedded-application strip 818D-1 is displayed, keyboard module 122 may cause UID 112 to display embedded-application strip 818D-2 which includes a second group of graphical buttons. The first group of graphical buttons represents a first page or tab of buttons and the second group of graphical buttons represents a different page or tab of buttons.

FIG. 6A further shows how keyboard module 122 may cause UID 112 to display embedded-application experience 818B-1 as a default embedded-application experience while displaying embedded-application strip 818D-1. FIG. 6B shows how after detecting input at UID 112 at a location at which embedded-application strip 818D-1 is displayed, keyboard module 122 may cause UID 112 to display embedded-application experience 818B-2 as a default embedded-application experience while displaying embedded-application strip 818D-2. By enabling pages or different default embedded-application experiences, keyboard module 122 may improve usability of graphical keyboard 816B as the quantity of inputs required from a user to toggle to a different embedded-application experience may be reduced.

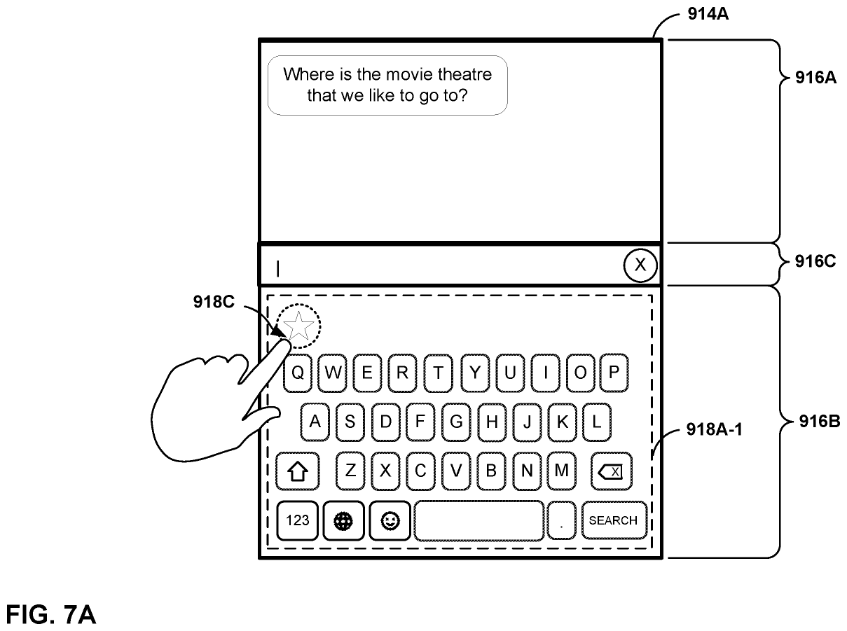

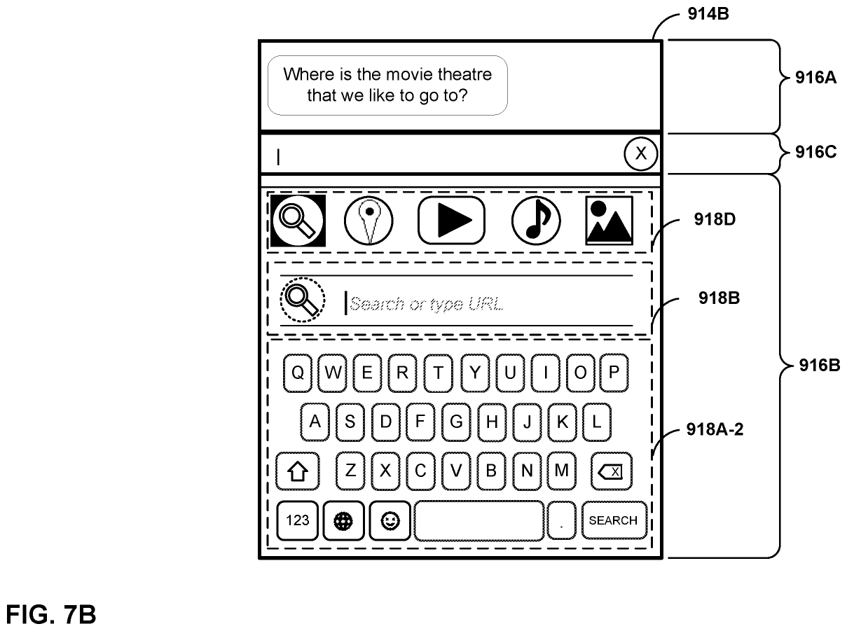

FIGS. 7A and 7B are conceptual diagrams illustrating example graphical user interfaces of an example computing device that is configured to present a graphical keyboard that executes one or more embedded-applications, in accordance with one or more aspects of the present disclosure.

FIGS. 7A-7B illustrate, respectively, example graphical user interfaces 914A-914B (collectively, user interfaces 914). However, many other examples of graphical user interfaces may be used in other instances. Each of graphical user interfaces 914 may correspond to a graphical user interface displayed by computing devices 110 or 210 of FIGS. 1A, 1B, and 2. FIGS. 7A and 7B are described below in the context of computing device 110.

Graphical user interfaces 914 include output region 916A, edit region 916C, and graphical keyboard 916B. Graphical keyboard 916B includes a plurality of keys 918A-1, or a plurality of keys 918A-2, embedded-application experience 918B, and embedded-application strip 918D.

As shown in FIG. 7A, in some examples, when operating in text-entry mode, keyboard module 122 may cause graphical keyboard 116B to include graphical element 918C as one of keys 918A-1. Graphical element 918C represents a selectable element (e.g., an icon, an image, a keyboard key, or other graphical element) of graphical keyboard 116B for manually invoking one or more of the various embedded-application experiences accessible from within graphical keyboard 116B.

For instance, as shown in FIG. 7B, in response to detecting input at a location of UID 112 at which graphical element 918C is displayed, keyboard module 122 may determine the user selects graphical element 918C. Keyboard module 122 may transition from operating in text-entry mode to operating in embedded-application mode and cause UID 112 to display graphical keys 918A-2 in place of graphical keys 918A-1 in response to detecting input associated with graphical element 918C. While operating in embedded-application mode, keyboard module 122 may cause graphical keyboard to display embedded-application experience 918B and/or embedded-application strip 918D within graphical keyboard 916B.

Some aspects of this disclosure include outputting, by a keyboard application executing at a computing device, for display, a graphical keyboard that includes an embedded-application strip. In some cases, the embedded-application strip includes one or more graphical elements, with each graphical element corresponding to a particular embedded-application from a plurality of embedded-applications that are each executable by the keyboard application. The plurality of embedded-applications include, in some instances, a search type embedded-application, a calendar type embedded-application, a video type embedded-application, a photo type embedded-application, a map or navigation type embedded-application, a music type embedded-application, or the like.

Some of the aspects include receiving user input that selects the embedded-application strip, determining, by the keyboard application, a particular embedded-application based on the user input, and launching, by the keyboard application, the particular embedded-application. In some cases, the keyboard application highlights, within the embedded-application strip, the graphical element of the particular embedded-application in response to receiving the user input that selects the embedded-application strip. In some cases, launching the particular embedded-application includes initiating, by the keyboard application, one or more application threads for executing operations of the particular embedded-application.

Some of the aspects include outputting, by the keyboard application, for display, an embedded-application experience associated with the particular embedded-application. In some examples, outputting the embedded-application experience includes displaying a GUI of the particular embedded-application in place of some, or in place of all, graphical keys of the graphical keyboard. In some cases, the particular embedded-application experience includes application controls that are specific to the particular embedded-application. In some cases, the particular embedded-application experience includes selectable content, such as one or more content cards.

Some of the aspects include receiving user input associated with the embedded-application experience and performing operations based on the user input associated with the embedded-application experience. In some cases, the user input associated with the embedded-application experience includes an input for selecting content of the embedded-application experience. And in some cases, performing operations based on the user input associated with the embedded-application experience includes inputting the selected content into a body of text composed with the graphical keyboard of the keyboard application. In some instances, the body of text is a message or document or an edit region of a GUI for composing the message or document.

Some of the aspects include receiving additional user input associated with the embedded-application strip and in response to the additional user input: launching, by the keyboard application, a different embedded-application and performing, by the keyboard application, operations related to the different embedded-application. In some cases, performing operations related to the different embedded-application include replacing the embedded-application experience display previously with a new embedded-application experience associated with the different application.

In some of the aspects the embedded-application strip is scrollable. In some of the aspects the embedded-application strip includes multiple pages of selectable graphical elements. In some of the aspects, the embedded-application strip is positioned above at least some of the keys of the graphical keyboard. In some aspects, the embedded-application strip is positioned below or at one side of at least some of the keys of the graphical keyboard. In some aspects, part of the embedded-application strip is positioned in one area of the graphical keyboard and other parts of the embedded-application strip are positioned in other areas of the graphical keyboard.

In some of the aspects, the graphical keyboard includes a particular graphical element or key that when selected, causes the keyboard application to display the embedded-application strip.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a keyboard application executing at a computing device, for display, a graphical keyboard that includes an embedded-application strip, wherein the embedded-application strip includes one or more graphical elements, with each graphical element corresponding to a particular embedded-application from a plurality of embedded-applications that are each executable by the keyboard application;
receiving, by the keyboard application, user input that selects the embedded-application strip;
determining, by the keyboard application, a particular embedded-application based on the user input; and
launching, by the keyboard application, the particular embedded-application.

2. The method of claim 1, wherein the plurality of embedded-applications includes two or more of a search type embedded-application, a calendar type embedded-application, a video type embedded-application, a photo type embedded-application, a map or navigation type embedded-application, a music type embedded-application.

3. The method of any one of claim 1 or 2, further comprising:
highlighting, by the keyboard application, within the embedded-application strip, the graphical element of the particular embedded-application in response to receiving the user input that selects the embedded-application strip.

4. The method of any one of claims 1-3, wherein launching the particular embedded-application comprises initiating, by the keyboard application, one or more application threads for executing operations of the particular embedded-application.

5. The method of any one of claims 1-4, further comprising:
outputting, by the keyboard application, for display, an embedded-application experience associated with the particular embedded-application by at least displaying a graphical user interface of the particular embedded-application in place of at least some graphical keys of the graphical keyboard.

6. The method of claim 5, further comprising:
receiving, by the keyboard application, user input associated with the embedded-application experience; and
performing, by the keyboard application, one or more operations based on the user input associated with the embedded-application experience.

7. The method of any one of claims 1-6, further comprising:
receiving, by the keyboard application, additional user input associated with the embedded-application strip; and
responsive to receiving the additional user input:
launching, by the keyboard application, a different embedded-application; and
performing, by the keyboard application, one or more operations related to the different embedded-application.

8. The method of claim 7, wherein the one or more operations related to the different embedded-application include replacing an embedded-application experience displayed previously with a new embedded-application experience associated with the different application.

9. The method of any one of claims 1-8, wherein the embedded-application strip is scrollable.

10. The method of any one of claims 1-9, wherein the embedded-application strip includes multiple pages of selectable graphical elements.

11. The method of any one of claims 1-10, wherein the embedded-application strip is positioned above at least some of the keys of the graphical keyboard or the embedded-application strip is positioned below or at one side of at least some of the keys of the graphical keyboard.

12. The method of any one of claims 1-11, wherein the embedded-application strip is positioned in one area of the graphical keyboard and other parts of the embedded-application strip are positioned in other areas of the graphical keyboard.

13. The method of any one of claims 1-12, wherein the graphical keyboard includes a particular graphical element or key that when selected, causes the keyboard application to display the embedded-application strip.

14. A computing device comprising at least one processor configured to perform any one of the methods of claims 1-13.

15. A system comprising means for performing any one of the methods of claims 1-13.
